(19) United States
(12) Patent Application Publication
(10) Pub. No.: US 2010/0288901 A1
(43) Pub. Date: Nov. 18, 2010

(54) Lateral tilt adapter for stationary exercise equipment

(76) Inventor: Mark S. Wallach, San Juan Capistrano, CA (US)

Correspondence Address: JONES DAY, 555 SOUTH FLOWER STREET FIFTIETH FLOOR, LOS ANGELES, CA, 90071, US

(21) Appl. No.: 12/454,265

(22) Filed: May 14, 2009

(51) Int. Cl. F16M 11/00

(52) U.S. Cl. 248/346.03

(57) ABSTRACT

An adapter for stationary exercise equipment that connects to stationary exercise equipment and adapts such equipment to laterally tilt in order to naturally and realistically simulate the leaning that normally occurs during actual vehicle use, such as during actual bicycle riding or boat rowing. The adapter is comprised of a platform or frame, with elastic material underneath, and arc-shaped supports that are shaped and positioned such that the platform tends to tilt away from the horizontal when a user is aboard the affixed stationary equipment, unless corrective forces are applied during use in order to maintain a horizontal position.

### BACKGROUND OF THE INVENTION

The field of the present invention is exercise devices, specifically, an improved, lateral tilt adapter for stationary exercise equipment.

The health benefits of exercising by way of exercise equipment, such as stationary exercise bicycles and recumbent bicycles, rowing machines, elliptical machines, etc., are well known and are useful exercise devices as they allow the user to exercise large group muscles and generally maintain or improve cardiovascular fitness in a controlled and often indoor environment. These devices, however, typically are fixed in place and thus incapable of leaning during use. To that extent, such designs fail to fully simulate the intended vehicle (such as an actual bicycle or row boat), as during actual use of such vehicles, the user is required to maintain balance during use given the propensity of the vehicle to lean. Moreover, the user of actual vehicles typically must lean to some degree in order to turn, which stationary exercise equipment also fail to simulate. These are important differences because riding an actual vehicle requires a certain expenditure of energy and attention in order to prevent leaning when traveling straight-line, or to initiate and maintain leaning during a turn.

Stationary exercise equipment that lean is known in the art. (See, e.g., U.S. Pat. No. 4,021,034 (to Olesen); U.S. Pat. No. 7,081,070 B1 (to Washington et al.); U.S. Pat. No. 7,438,672 B1 (to Rylander et al.); U.S. Patent Application Publication No. US 2009/0048076 A1 (of Irving et al.). However, such devices have drawbacks and other limitations. For example, they are designed such that the lean of the device is controlled or impeded by certain mechanical constraints. Such designs fail to effectively simulate the natural feel and lean of riding an actual vehicle. Also, some are designed such that the stationary exercise equipment is intended to be permanently mounted or irreversibly connected to the leaning mechanism, resulting in the inability to quickly and easily adapt any non-leaning stationary device into one that has a natural feeling of leaning.

### SUMMARY OF THE PRESENT INVENTION

In view of the foregoing disadvantages and problems inherent in the devices disclosed in the prior art, the present invention is an improved device that permits a user to readily adapt any typical stationary exercise equipment, such as such as stationary exercise bicycles and recumbent bicycles, rowing machines, elliptical machines, etc., to tilt or lean during use, in a manner in which the tilt or lean more closely matches or approximates that of actual vehicle use.

As will be described in greater detail below, the present invention accomplishes the foregoing by way of a platform or frame, to which are attached underneath at least two arc-shaped supports, and also an elastic material. The platform is adapted to allow any typical stationary exercise equipment to be readily mounted thereto. As a result of the specific shape of the arc-shaped supports, and their height relative to the elastic material, the user of the stationary exercise equipment is able to experience a more realistic and natural leaning simulation than devices disclosed in the prior art.

The foregoing description, objects, and advantages of the present invention are not meant to be an exhaustive summary, inasmuch as additional pertinent aspects of this invention will be readily apparent to those skilled in the art from the following detailed description, taken independently or in conjunction with the annexed sheets of drawings, in which one or more embodiments of the invention are described and shown. The following detailed description and annexed drawings are provided only for purposes of illustration of certain specific embodiments of the present invention, and not for purposes of limitation of the appended claims.

### BRIEF DESCRIPTION OF THE DRAWINGS

The following detailed description of the invention can be better understood with reference to the accompanying drawings, wherein:

FIG. 1 is a front, perspective view of the adapter device in accordance with the present invention;

FIG. 2 is a front, perspective view of the adapter device in accordance with an alternate embodiment of the present invention;

FIG. 3 is a front view of the adapter device in accordance with the present invention;

FIG. 4 is a front view of the adapter device in accordance with an alternate embodiment of the present invention;

FIG. 5 is front view of the adapter device of the present invention shown tilting to one side;

FIG. 6 is front view of the adapter device of the present invention depicting the adapter device in motion, tilting from one side to the other;

FIG. 7 is a front view of the adapter device in accordance with an alternate embodiment of the present invention;

FIG. 8 is a front view of the adapter device in accordance with an alternate embodiment of the present invention;

FIG. 9 is front view of the adapter device of the present invention shown tilting to one side;

FIG. 10 is front view of the adapter device of the present invention depicting the adapter device in motion, tilting from one side to the other; and

FIG. 11 is a side view of the adapter device in accordance with an alternate embodiment of the present invention.

In the drawings, similar reference characters denote similar elements throughout the several views, as well as within the detailed description below.

### DETAILED DESCRIPTION OF A PREFERRED EMBODIMENT

As noted above, the following detailed description is not meant to limit the present claimed invention, inasmuch as alternate embodiments will be readily apparent to those skilled in the art.

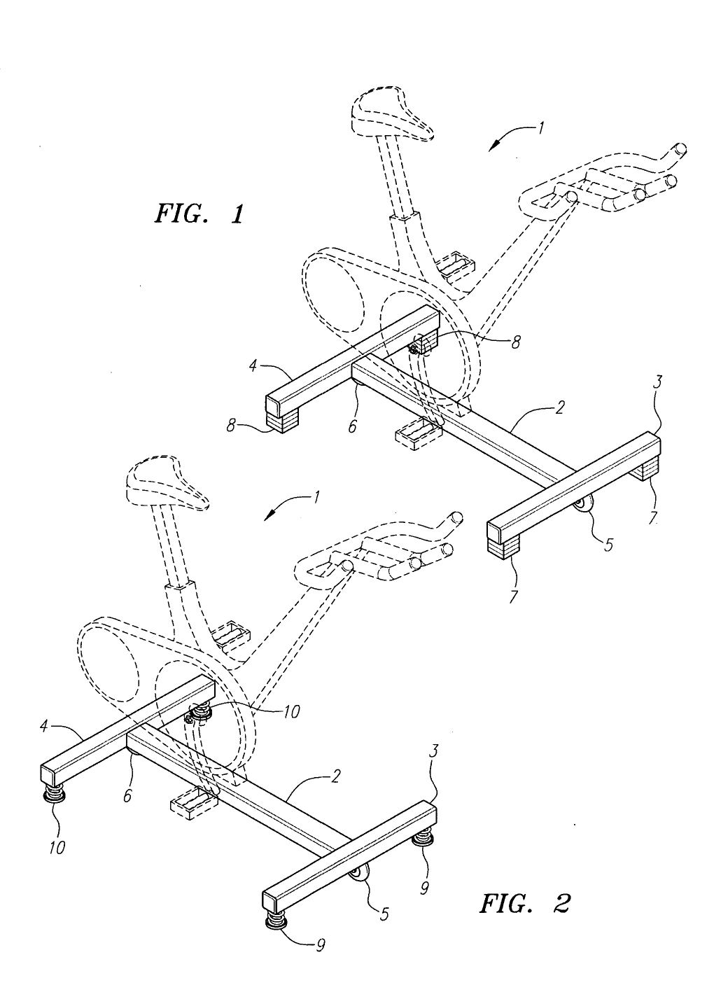

Referring to FIGS. 1, 2, and 12 an adapter device is shown in accordance with the present invention, comprising a platform or frame, which, in the illustrated preferred embodiment, is comprised of a longitudinal bar 2, and lateral bars 3 and 4. Any typical stationary exercise device (such as, for example, a stationary exercise bicycle 1 (see FIGS. 1 and 2) or, for example, a stationary rowing machine 1 1 (see FIG. 12) can be mounted or affixed to the platform by way of any number of mechanisms that will be apparent to those of skill in the art, such as by bolts, screws, rivets, straps, adhesives, and/or other mechanisms, which allow ready and easy reversal and removal of the stationary exercise equipment such that the adapter device can be easily fitted to other exercise equipment. Longitudinal bar 2 and lateral bars 3 and 4 can be made of any type of rigid material, preferably metal, but can include plastics, polymers, composites, and other materials.

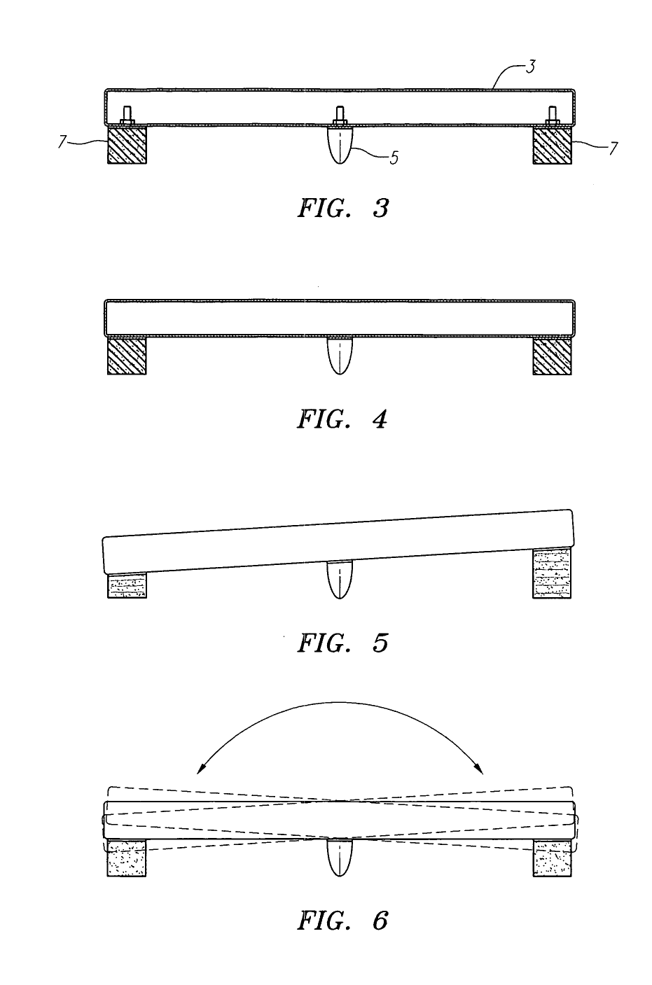

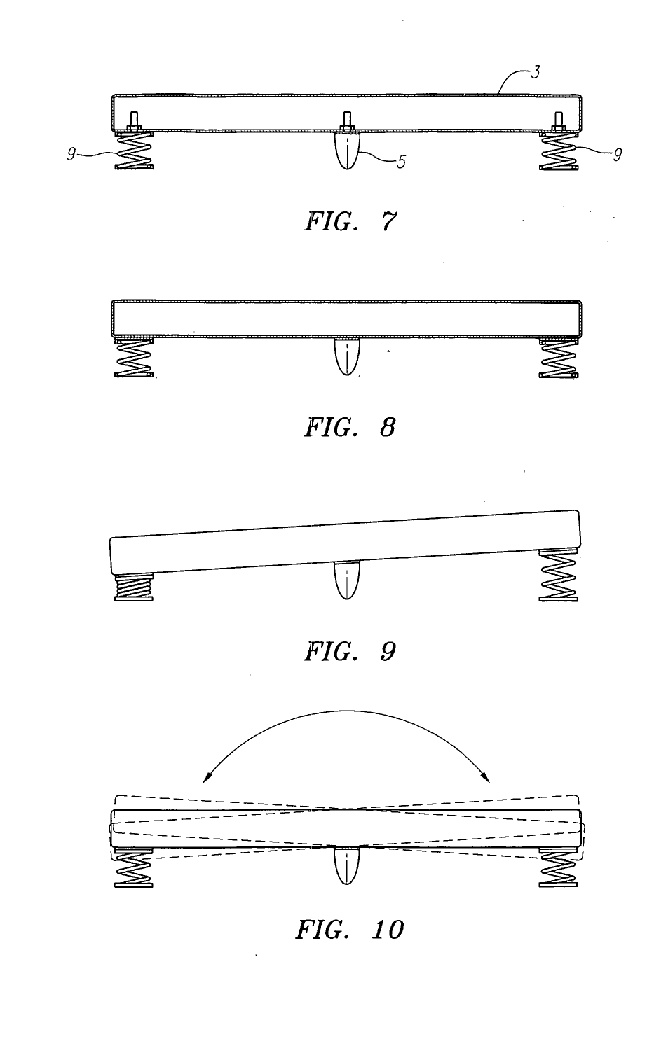

Referring to FIGS. 1 and 12, at each end of each of the lateral bars 3 and 4 is affixed underneath an elastic material 7 and 8. The elastic material 7 and 8 can be any material known by those of skill in the art that will compress when pressure is applied, and return to its original state or near original state when pressure is removed, such plastics, rubber, polymers, or composite materials. In an alternate embodiment, a spring may be used. (See FIG. 2, springs 9 and 10; see also FIGS. 7, 8, and 11.) The elastic material may be affixed using commonly known mechanisms, such as bolts and nuts (FIGS. 3 and 7), or by way of adhesives (FIGS. 4 and 8), or other known mechanisms and techniques.

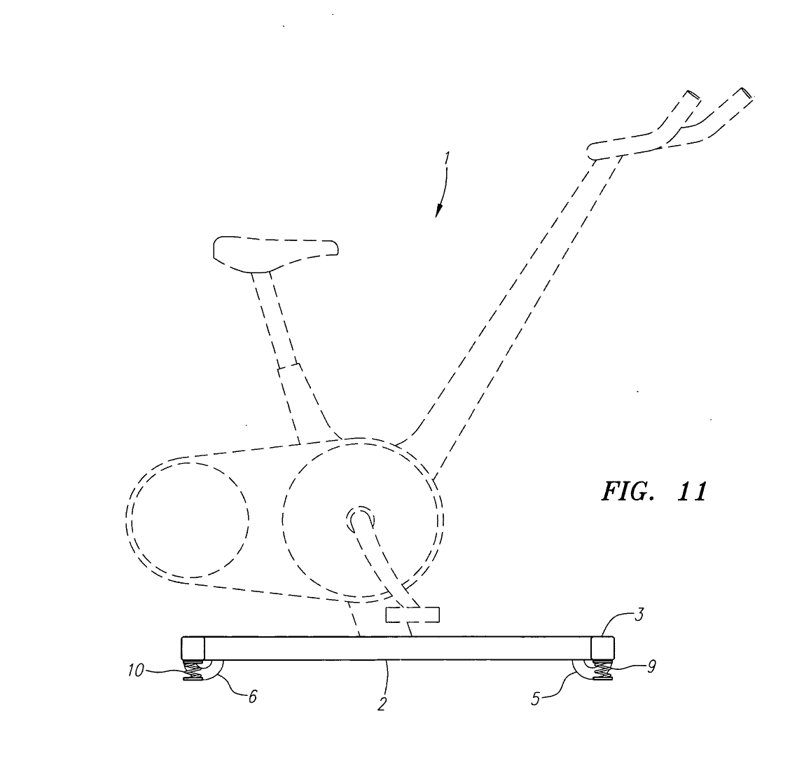

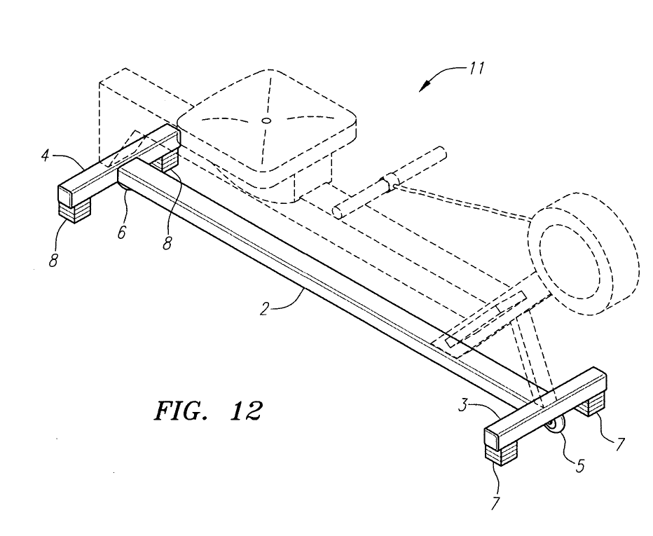

Referring to FIGS. 1, 2, and 12, arc-shaped support 5 is attached near the front portion of the platform, and arc-shaped support 6 is attached near the rear portion of the platform. The front profile of the arc-shaped supports is shown in FIGS. 3 and 7, and the side profile is shown in FIG. 11. The front/rear profile of the arc-shaped supports 5 and 6, as depicted in FIGS. 3 and 7 showing the front profile of arc-shaped support 5, can be of a shape that tapers towards the bottom, forming a more pointed profile when viewed from the front (or rear). Alternatively, the front/rear profile of arc-shaped supports 5 and 6 can be less tapered, i.e., more rounded in shape towards the bottom, forming less of a pointed profile when viewed from the front (or rear). The arc-shaped supports 5 and 6 can be sufficiently tall in size relative to the elastic material, such that when the platform is in a horizontal position, very little if any pressure is applied to the elastic material 7 and 8 (or 9 and 10). In such an embodiment, the platform will tend to naturally tilt in a lateral direction unless the user applies counteracting forces to keep the platform level. This result also can be achieved by an alternate embodiment in which the elastic material 7 and 8 (or 9 and 10) is more pliable or soft, such that the platform will tend to naturally tilt in a lateral direction because the elastic material is too pliable or soft to fully support the weight of the platform, or the platform with the user aboard.

The propensity by which the platform tends to naturally tilt can be altered by changing the amount of taper at the bottom of the arc-shaped supports 5 and 6. The amount by which the platform will tilt can be altered by varying the height of the arc-shaped supports relative to the elastic material, or the pliability or softness of the elastic material. The arc-shaped supports can be made of numerous materials, but preferably a rigid or semi-rigid material, including plastics, rubber, polymers, composites, and other similar materials. The arc-shaped supports may be affixed using commonly known mechanisms, such as bolts and nuts (FIGS. 3 and 7), or by way of adhesives (FIGS. 4 and 8), or other known mechanisms and techniques.

In operation, the platform, as depicted in FIGS. 5 and 6 (and alternatively, FIGS. 9 and 10) tends to readily tilt with a user aboard the affixed stationary exercise equipment, unless corrective forces are supplied, either directly by the stationary equipment user, or by virtue of forces generated while the user operates the stationary exercise equipment (such as the centrifugal forces generated by the spinning of a wheel of a stationary exercise bicycle). The shape and position of the arc-shaped supports prevent the platform from tilting longitudinally during use.

Although particular embodiments of the invention have been described and illustrated herein in detail, it is recognized that modifications may readily occur to those skilled in the art. Consequently, it is intended that the claims herein be interpreted to cover any such modifications. It is further intended that the present invention be not limited according to any particular disclosed embodiment, but rather only according to the appended claims.

What is claimed is:

1. An adapter device for stationary exercise equipment comprising:
a platform, said platform having a front portion and a rear portion, and a right side and a left side;
said platform having affixed underneath, on the right side near the front portion, on the left side near the front portion, on the right side near the rear portion, and on the left side near the rear portion, an elastic material;
said platform having affixed underneath, near the front portion and near the rear portion and positioned along the longitudinal centerline of the platform, an arc-shaped support of sufficient height as to allow the device to tilt laterally in either direction, but adapted to prevent longitudinal tilt;
said platform adapted to receive and connect thereto stationary exercise equipment.

2. The adapter device according to claim 1, wherein said platform is comprised of a longitudinal bar having a front portion and a rear portion, said longitudinal bar having a first lateral bar affixed near the front portion of said longitudinal bar and a second lateral bar affixed near the rear portion of said longitudinal bar.

3. The adapter device according to claim 1, wherein said elastic material is a spring.

4. The adapter device according to claim 1, wherein said stationary exercise equipment is a stationary exercise bicycle.

5. The adapter device according to claim 4, wherein said stationary exercise bicycle is a recumbent bicycle.

6. The adapter device according to claim 1, wherein said stationary exercise equipment is a stationary rowing machine.

7. The adapter device according to claim 1, wherein said stationary exercise equipment is a stationary elliptical exercise machine.

8. A method of adapting stationary exercise equipment to lean laterally by affixing stationary exercise equipment to an adapter device, wherein said adapter device comprises:
a platform, said platform having a front portion and a rear portion, and a right side and a left side;
said platform having affixed underneath, on the right side near the front portion, on the left side near the front portion, on the right side near the rear portion, and on the left side near the rear portion, an elastic material;
said platform having affixed underneath, near the front portion and near the rear portion and positioned along the longitudinal centerline of the platform, an arc-shaped support of sufficient height as to allow the device to tilt laterally in either direction, but adapted to prevent longitudinal tilt;
said platform adapted to receive and connect thereto stationary exercise equipment.

9. The method according to claim 8, wherein said platform is comprised of a longitudinal bar having a front portion and a rear portion, said longitudinal bar having a first lateral bar affixed near the front portion of said longitudinal bar and a second lateral bar affixed near the rear portion of said longitudinal bar.

10. The method according to claim 8, wherein said elastic material is a spring.

11. The method according to claim 8, wherein said stationary exercise equipment is a stationary exercise bicycle.

12. The method according to claim 11, wherein said stationary exercise bicycle is a recumbent bicycle.

13. The method according to claim 8, wherein said stationary exercise equipment is a stationary rowing machine.

14. The method according to claim 8, wherein said stationary exercise equipment is a stationary elliptical exercise machine.

15. An adapter device for stationary exercise equipment comprising:
a longitudinal bar;
said longitudinal bar having a front portion and a rear portion;
said longitudinal bar having a first lateral bar affixed near the front portion of said longitudinal bar and a second lateral bar affixed near the rear portion of said longitudinal bar, said first and second lateral bars each having a right portion and a left portion, said longitudinal bar, first lateral bar, and second lateral bar forming a frame, said frame having a front portion and a rear portion;
said first lateral bar having affixed underneath, near the right portion of said first lateral bar and also near the left portion of said first lateral bar, an elastic material;
said second lateral bar having affixed underneath, near the right portion of said second lateral bar and also near the left portion of said second lateral bar, an elastic material;
said frame having affixed underneath, near the front portion of said frame and also near the rear portion of said frame, an arc-shaped support of sufficient height as to allow the device to tilt laterally in either direction, but adapted to prevent longitudinal tilt;
said frame adapted to receive and connect thereto stationary exercise equipment.

16. The adapter device according to claim 15, wherein said elastic material is a spring.

17. The adapter device according to claim 15, wherein said stationary exercise equipment is a stationary exercise bicycle.

18. The adapter device according to claim 17, wherein said stationary exercise bicycle is a recumbent bicycle.

19. The adapter device according to claim 15, wherein said stationary exercise equipment is a stationary rowing machine.

20. The adapter device according to claim 15, wherein said stationary exercise equipment is a stationary elliptical exercise machine.
